(19) United States
(12) Patent Application Publication
(10) Pub. No.: US 2026/0155072 A1
(43) Pub. Date: Jun. 4, 2026

(54) ELECTRONIC DEVICE

(71) Applicant: Innolux Corporation, Miaoli County (TW)

(72) Inventors: Min-Hsin Lo, Miaoli County (TW); Ming-Chun Tseng, Miaoli County (TW); Hung-Sheng Liao, Miaoli County (TW)

(73) Assignee: Innolux Corporation, Miaoli County (TW)

(21) Appl. No.: 19/387,567

(22) Filed: Nov. 12, 2025

Related U.S. Application Data
(60) Provisional application No. 63/726,331, filed on Nov. 29, 2024.

(30) Foreign Application Priority Data
Jun. 26, 2025 (CN) 202510872397.1

(51) Int. Cl. G09G 3/20

(52) U.S. Cl. CPC G09G 3/20; G09G 2310/0213; G09G 2310/0267; G09G 2310/04; G09G 2310/08

(57) ABSTRACT

An electronic device includes a substrate, a first electronic component, a second electronic component, a first drive circuit, a second drive circuit, and a first control circuit. The first electronic component and the second electronic component are arranged in a first area of the substrate. The first drive circuit and the second drive circuit are arranged in a second area of the substrate. The first drive circuit is coupled to the first electronic component. The second drive circuit is coupled to the second electronic component. The first control circuit is arranged in the second area of the substrate and is coupled to the first drive circuit and the second drive circuit. The first control circuit includes a first judgment transistor, a second judgment transistor, a first input control transistor, a second input control transistor, a first reset transistor, and a first capacitor.

### CROSS-REFERENCE TO RELATED APPLICATION

This application claims the priority benefits of U.S. provisional application Ser. No. 63/726,331, filed on Nov. 29, 2024, and China application serial no. 202510872397.1, filed on Jun. 26, 2025. The entirety of each of the above-mentioned patent applications is hereby incorporated by reference herein and made a part of this specification.

### BACKGROUND

### Technical Field

The disclosure relates to a device, and particularly relates to an electronic device.

### Related Art

Multiple electronic components of conventional electronic devices may merely operate at the same refresh rate or the same duty cycle, and it is not possible for multiple electronic components arranged on the same substrate to operate in a multi-mode operation under different refresh rates or different duty cycles.

### SUMMARY

According to an embodiment of the disclosure, an electronic device includes a substrate, first and second electronic components, first and second drive circuit, and a first control circuit. The first electronic component is arranged in a first area of the substrate. The second electronic component is arranged in the first area of the substrate. The first drive circuit is arranged in a second area of the substrate and coupled to the first electronic component. The second drive circuit is arranged in the second area of the substrate and coupled to the second electronic component. The first control circuit is arranged in the second area of the substrate and coupled to the first drive circuit and the second drive circuit. The first control circuit includes a first judgment transistor, a second judgment transistor, a first input control transistor, a second input control transistor, a first reset transistor, and a first capacitor.

Based on the above, the electronic device of the disclosure may enable different electronic components to operate in different operation modes.

### BRIEF DESCRIPTION OF THE DRAWINGS

FIG. 1 is a schematic diagram of an electronic device of an embodiment of the disclosure.

FIG. 2 is a schematic diagram of a control circuit and a drive circuit of an embodiment of the disclosure.

FIG. 3 is a schematic diagram of a control circuit and a drive circuit of another embodiment of the disclosure.

FIG. 4 is a timing diagram of multiple signals of an embodiment of the disclosure.

FIG. 5 is a schematic diagram of a control circuit and a drive circuit of another embodiment of the disclosure.

### DESCRIPTION OF THE EMBODIMENTS

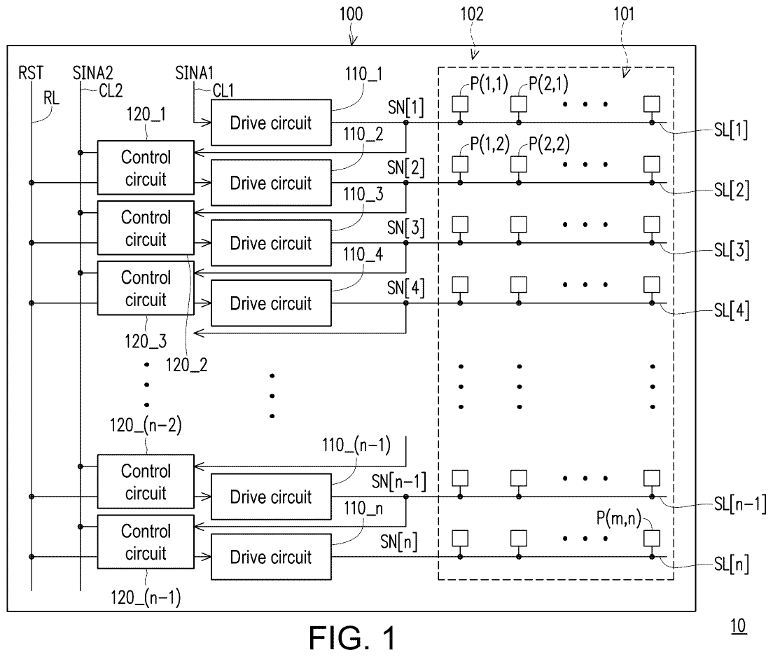

Referring to FIG. 1, an electronic device 10 includes a substrate 100, a plurality of drive circuits 110_1˜110_n, a plurality of control circuits 120_1˜120_(n-1), and a plurality of electronic components P(1,1)˜P(m,n), where m and n are positive integers respectively. The drive circuits 110_1˜110_n, the control circuits 120_1˜120_(n-1), and the electronic components P(1,1)˜P(m,n) are formed on the substrate 100. The substrate 100 includes a first area 101 and a second area 102. The first area 101 is an active area (AA), and the second area 102 is a peripheral area. The second area 102 surrounds the first area 101. It should be noted that FIG. 1 is merely used to represent the arrangement rules of each component on the substrate 100, and the area ranges of the first area 101 and the second area 102 are not limited to as shown in FIG. 1. Additionally, in one embodiment, the electronic device 10 may also have at least one control circuit. The number of control circuits is not limited to as shown in FIG. 1.

The electronic components P(1,1)˜P(m,n) are arranged in the first area 101 of the substrate 100, and the electronic components P(1,1)˜P(m,n) are arranged in an array in the first area 101. The drive circuits 110_1˜110_n and the control circuits 120_1˜120_(n-1) are arranged in the second area 102 of the substrate 100. The drive circuits 110_1˜110_n are coupled to the electronic components P(1,1)˜P(m,n) through signal lines SL[1]˜SL[n]. The drive circuit 110_1 is coupled to a plurality of electronic components P(1,1)˜P(m,1) in a row through the signal line SL[1]. The drive circuit 110_2 is coupled to a plurality of electronic components P(1,2)˜P(m,2) in a row through the signal line SL[2]. By analogy, the drive circuit 110_n is coupled to a plurality of electronic components P(1,n)˜P(m,n) in a row through the signal line SL[n]. In one embodiment of the disclosure, the electronic device 10 may further include another plurality of drive circuits and another plurality of control circuits are disposed on another side of the second area 102 of the substrate 100. The another plurality of drive circuits may drive another multiple electronic components of another region of the first area 101 through another plurality of signal lines.

The control circuits 120_1˜120_(n-1) are coupled to the drive circuits 110_1˜110_n. The control circuits 120_1˜120_(n-1) are respectively coupled between two adjacent drive circuits. The control circuit 120_1 is coupled to the output terminal of the drive circuit 110_1 and the input terminal of the drive circuit 110_2. The control circuit 120_2 is coupled to the output terminal of the drive circuit 110_2 and the input terminal of the drive circuit 110_3. By analogy, the control circuit 120_n is coupled to the output terminal of the drive circuit 110_(n-1) and the input terminal of the drive circuit 110_n. The input terminal of the drive circuit 110_1 is coupled to an input signal line CL1. The control circuits 120_1˜120_(n-1) are coupled to an input signal line CL2 and a reset signal line RL. The drive circuit 110_1 receives a first input signal SINA1 through the input signal line CL1. The control circuits 120_1˜120_(n-1) receives a second input signal SINA2 through the input signal line CL2, and receives a reset signal RST through the reset signal line RL.

The first stage drive circuit 110_1 generates an output signal SN[1] according to the first input signal SINA1. The drive circuit 110_1 outputs the output signal SN[1] to the electronic components P(1,1)˜P(m,1) through the signal line SL[1], and provides the output signal SN[1] to the first stage control circuit 120_1. The control circuit 120_1 outputs the output signal SN[1] or the second input signal SINA2 to the drive circuit 110_2, so that the drive circuit 110_2 generates an output signal SN[2] according to the output signal SN[1] or the second input signal SINA2. The drive circuit 110_2 outputs the output signal SN[2] to the electronic components P(1,2)˜P(m,2) through the signal line SL[2], and provides the output signal SN[2] to the next stage control circuit 120_2. By analogy, the drive circuit 110_(n-1) outputs the output signal SN[n-1] to the electronic components P(1,(n-1))˜P(m,(n-1)) through the signal line SL[n-1], and provides the output signal SN[n-1] to the last stage control circuit 120_(n-1). The control circuit 120_(n-1) outputs the output signal SN[n-1] or the second input signal SINA2 to the last stage drive circuit 110_n, so that the drive circuit 110_n generates the output signal SN[n] according to the output signal SN[n-1] or the second input signal SINA2. The drive circuit 110_n outputs the output signal SN[n] to the electronic components P(1,n)˜P(m,n) through the signal line SL[n]. The electronic device 10 may be a display panel. The electronic components P(1,1)˜P(m,n) may respectively be pixel circuits and respectively serve as display pixel units.

In one embodiment, the drive circuits 110_1˜110_n may respectively be scan drive circuits. The drive circuits 110_1˜110_n outputs multiple scan signals to multiple electronic components in different rows. The first input signal SINA1 and the second input signal SINA2 may respectively be two scan signals having the same refresh rate or different refresh rates. The refresh rate may be, for example, a screen refresh rate. The control circuit 120_1 receives the first input signal SINA1, and the control circuits 120_2˜120_(n-1) respectively receive the scan signal output by the previous stage drive circuit having the same refresh rate or different refresh rates and the second input signal SINA2. The control circuits 120_1˜120_(n-1) may respectively be used to operate multiple electronic components in adjacent two rows at the same refresh rate or different refresh rates through two drive circuits coupled thereto.

The drive circuits 110_1˜110_n may respectively be emission drive circuits. The drive circuits 110_1˜110_n output multiple emission signals to multiple electronic components in different rows. The first input signal SINA1 and the second input signal SINA2 may respectively be two emission signals having the same duty cycle or different duty cycles. The control circuit 120_1 receives the first input signal SINA1, and the control circuits 120_2˜120_(n-1) respectively receive the emission signal output by the previous stage drive circuit having the same duty cycle or different duty cycles and the second input signal SINA2. The control circuits 120_1˜120_(n-1) may respectively be used to operate multiple electronic components in adjacent two rows at the same duty cycle or different duty cycles through two drive circuits coupled thereto.

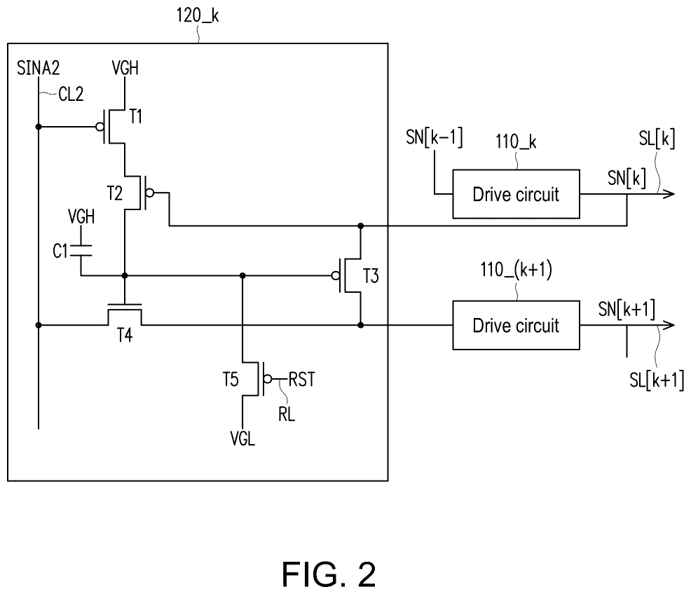

Referring to FIG. 2, the following description takes two adjacent drive circuits and one control circuit in FIG. 1 as an example. Each of the multiple control circuits 120_1˜120_(n-1) in FIG. 1 may implement the circuit architecture as shown in FIG. 2. The control circuit 120_k is coupled to the drive circuit 110_k and the drive circuit 110_(k+1), where k is a positive integer between 1 and n. The input terminal of the drive circuit 110_k receives the signal SN[k−1] from the previous stage. The output terminal of the drive circuit 110_k may be coupled to multiple electronic components (not shown) through the signal line SL[k], and the output terminal of the next stage drive circuit 110_(k+1) may be coupled to other multiple electronic components (not shown) through the signal line SL[k+1]. The control circuit 120_k includes a transistor T1 (first judgment transistor), a transistor T2 (second judgment transistor), a transistor T3 (first input control transistor), a transistor T4 (second input control transistor), a transistor T5 (first reset transistor), and a capacitor C1 (first capacitor).

The first terminal of the transistor T1 is coupled to a reference voltage VGH. The second terminal of the transistor T1 is coupled to the first terminal of the transistor T2. The control terminal of the transistor T1 is coupled to the input signal line CL2. The control terminal of the transistor T2 is coupled to the output terminal of the drive circuit 110_k. The second terminal of the transistor T2 is coupled to the control terminal of the transistor T3 and the control terminal of the transistor T4. The first terminal of the transistor T3 is coupled to the output terminal of the drive circuit 110_k. The second terminal of the transistor T3 is coupled to the input terminal of the drive circuit 110_(k+1). The first terminal of the transistor T4 is coupled to the input signal line CL2. The second terminal of the transistor T4 is coupled to the second terminal of the transistor T3 and the input terminal of the drive circuit 110_(k+1). The first terminal of the transistor T5 is coupled to the control terminal of the transistor T3. The second terminal of the transistor T5 is coupled to a reference voltage VGL. The control terminal of the transistor T5 is coupled to the reset signal line RL. The first terminal of the capacitor C1 is coupled to the reference voltage VGH. The second terminal of the capacitor C1 is coupled to the second terminal of the transistor T2 and the control terminal of the transistor T4. The transistors T1 to T3, and T5 may be P-type transistors, and the transistor T4 may be an N-type transistor. The reference voltage VGH is higher than the reference voltage VGL.

The signal SN[k] output from the output terminal of the drive circuit 110_k may be provided to the input terminal of the drive circuit 110_(k+1) via the transistor T3, so that the drive circuit 110_(k+1) generates the signal SN[k+1] according to the signal SN[k] of the previous stage. The second input signal SINA2 may be provided to the input terminal of the drive circuit 110_(k+1) via the transistor T4, so that the drive circuit 110_(k+1) generates the signal SN[k+1] according to the second input signal SINA2. In other words, if the multiple electronic components driven by the drive circuit 110_k and the other multiple electronic components driven by the drive circuit 110_(k+1) are to operate in different operation modes respectively, then control may be achieved through the second input signal SINA2 transmitted by the input signal line CL2.

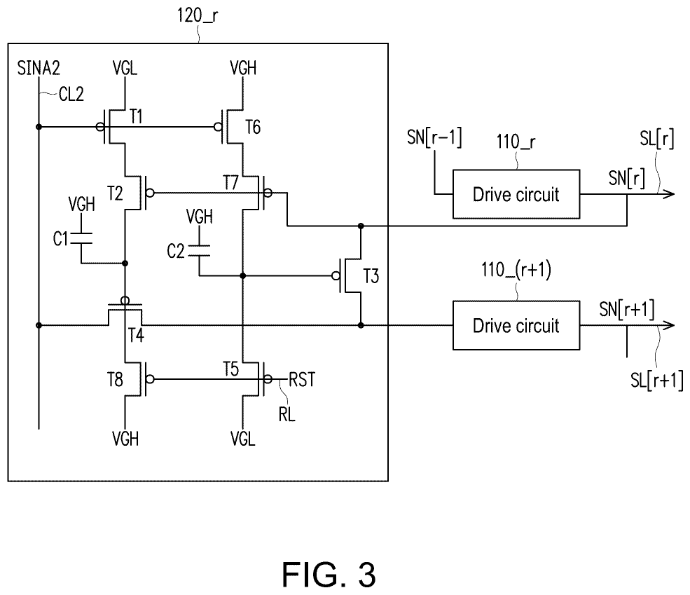

Referring to FIG. 3, the following description takes two adjacent drive circuits and one control circuit in FIG. 1 as an example. Each of the multiple control circuits 120_1˜120_(n-1) in FIG. 1 may implement the circuit architecture as shown in FIG. 3. The control circuit 120_r is coupled to the drive circuit 110_r and the drive circuit 110_(r+1), where r is a positive integer between 1 and n. The input terminal of the drive circuit 110_r receives the signal SN[r−1] from the previous stage. The output terminal of the drive circuit 110_r may be coupled to multiple electronic components (not shown) through the signal line SL[r], and the output terminal of the next stage drive circuit 110_(r+1) may be coupled to other multiple electronic components (not shown) through the signal line SL[r+1]. The control circuit 120_r includes transistors T1˜T6 (third judgment transistor), a transistor T7 (fourth judgment transistor), a transistor T8 (second reset transistor T8), capacitors C1 and C2 (second capacitor).

The first terminal of the transistor T1 is coupled to the reference voltage VGL. The second terminal of the transistor T1 is coupled to the first terminal of the transistor T2. The control terminal of the transistor T1 is coupled to the input signal line CL2. The control terminal of the transistor T2 is coupled to the output terminal of the drive circuit 110_r. The second terminal of the transistor T2 is coupled to the control terminal of the transistor T4. The first terminal of the transistor T3 is coupled to the output terminal of the drive circuit 110_r. The second terminal of the transistor T3 is coupled to the input terminal of the drive circuit 110_(r+1). The first terminal of the transistor T4 is coupled to the input signal line CL2. The second terminal of the transistor T4 is coupled to the second terminal of the transistor T3 and the input terminal of the drive circuit 110_(r+1). The control terminal of the transistor T4 is coupled to the second terminal of the transistor T2. The first terminal of the transistor T5 is coupled to the control terminal of the transistor T3. The second terminal of the transistor T5 is coupled to the reference voltage VGL. The control terminal of the transistor T5 is coupled to the reset signal line RL. The first terminal of the capacitor C1 is coupled to the reference voltage VGH. The second terminal of the capacitor C1 is coupled to the second terminal of the transistor T2 and the control terminal of the transistor T4. The first terminal of the transistor T6 is coupled to the reference voltage VGH. The control terminal of the transistor T6 is coupled to the input signal line CL2. The first terminal of the transistor T7 is coupled to the second terminal of the transistor T6. The control terminal of the transistor T7 is coupled to the output terminal of the drive circuit 110_r. The second terminal of the transistor T7 is coupled to the control terminal of the transistor T3 and the first terminal of the transistor T5. The first terminal of the transistor T8 is coupled to the second terminal of the transistor T2 and the control terminal of the transistor T4. The second terminal of the transistor T8 is coupled to the reference voltage VGH. The control terminal of the transistor T8 is coupled to the reset signal line RL. The first terminal of the capacitor C2 is coupled to the reference voltage VGH. The second terminal of the capacitor C2 is coupled to the control terminal of the second transistor T3. The transistors T1˜T8 are P-type transistors. The reference voltage VGL is lower than the second reference voltage VGH. The control terminals of the transistor T5 and the transistor T8 respectively receive the reset signal RST from the reset signal line RL to switch to the conductive state. The transistor T5 provides the reference voltage VGL to the control terminal of the transistor T3 to switch the transistor T3 to the conductive state. The transistor T8 provides the reference voltage VGH to the control terminal of the transistor T4 to switch the transistor T4 to the off state. In this way, the signal SN[r] output from the output terminal of the drive circuit 110_r may be provided to the input terminal of the drive circuit 110_(r+1) via the transistor T3, so that the drive circuit 110_(r+1) generates the signal SN[r+1] according to the signal SN[r] from the previous stage.

However, if the transistor T1 and the transistor T6 are conductive according to the second input signal SINA2, then the control terminal of the transistor T3 receives the reference voltage VGH via the transistor T6 and the third judgment transistor T7 and switch to the off state, and the control terminal of the transistor T4 receives the reference voltage VGL via the transistor T1 and the transistor T2 and switch to the conductive state. The second input signal SINA2 may be provided to the input terminal of the drive circuit 110_(r+1) via the transistor T4, so that the drive circuit 110_(r+1) generates the signal SN[r+1] according to the second input signal SINA2. In other words, if the multiple electronic components driven by the drive circuit 110_r and the other multiple electronic components driven by the drive circuit 110_(r+1) are to operate in different operation modes respectively, then control may be achieved through the second input signal SINA2 transmitted by the input signal line CL2.

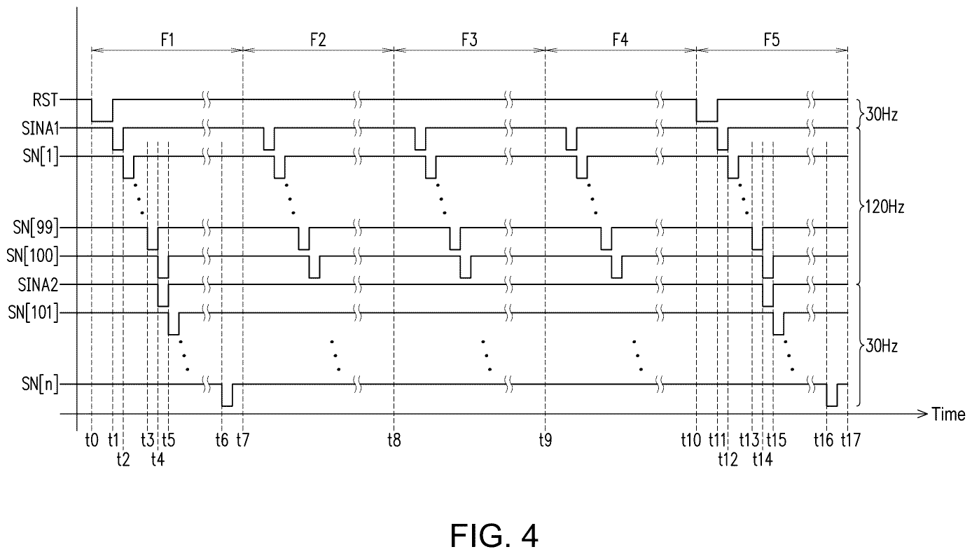

Referring to FIG. 1 and FIG. 4, the first input signal SINA1, the second input signal SINA2, and the reset signal RST of the electronic device 10 in FIG. 1 may implement the timing as shown in FIG. 4. Taking frame periods F1 to F5 as examples, when the multiple electronic components of the 1st row to the 100th row of the electronic device 10 are to operate at a refresh rate of 120 hertz (Hz), and the other multiple electronic components of the 101st row to the nth row are to operate at a refresh rate of 30 hertz (Hz), the control circuits 120_1˜120_(n-1) receives the reset signal RST having a refresh rate corresponding to 30 hertz (Hz). The reset signal RST may have pull-down pulse signals at the time t0 of the frame period F1 and the time t10 of the frame period F5 to turn on the reset transistors in the control circuits 120_1˜120_(n-1). The control circuits 120_1˜120_(n-1) may also receive the second input signal SINA2 having a refresh rate corresponding to 30 hertz (Hz). The second input signal SINA2 may have pull-down pulse signals at the time t4 of the frame period F1 and the time t14 of the frame period F5 to turn off the respective first input control transistors in the control circuits 120_1˜120_(n-1) (as shown in FIG. 2 and FIG. 3 above) and turn on the respective second input control transistors in the control circuits 120_1˜120_(n-1) (as shown in FIG. 2 and FIG. 3 above).

The drive circuit 110_1 receives the first input signal SINA1 having a refresh rate corresponding to 120 hertz (Hz) from the input signal line CL1. The first input signal SINA1 may have a pull-down pulse signal at the time t1 of the frame period F1. By analogy, from the frame period F2 to the frame period F5, there is a pull-down pulse signal at the time t11 of the frame period F5. In response, the drive circuit 110_1 outputs the output signal SN[1] also having a refresh rate corresponding to 120 hertz (Hz) to the multiple electronic components P(1,1)˜P(m,1) of the 1st row and the control circuit 120_1. The output signal SN[1] may have a pull-down pulse signal at the time t2 of the frame period F1. By analogy, from the frame period F2 to the frame period F5, there is a pull-down pulse signal at time t12 of the frame period F5. By analogy, the control circuits 120_2˜120_100 respectively receive the output signals SN[2]˜SN[100] output by the previous stage drive circuits 110_2˜110_100.

The control circuits 120_1˜120_99 sequentially output the pulse signals of the received output signals SN[1]˜SN[99] to the drive circuits 110_2˜110_100. The drive circuits 110_2˜110_100 output the output signals SN[2]˜SN[100] also having a refresh rate corresponding to 120 hertz (Hz) to the multiple electronic components P(1,2)˜P(m,100) of the 2nd row to the 100th row. The control circuit 120_100 switches to output the received second input signal SINA2 having a refresh rate corresponding to 30 hertz (Hz) to the drive circuit 110_101. The drive circuit 110_101 outputs the output signal SN[101] also having a refresh rate corresponding to 30 hertz (Hz) to the multiple electronic components P(1,101)˜P(m,101) of the 101st row and the control circuit 120_101. By analogy, the control circuits 120_102˜120_(n-1) sequentially output the pulse signals of the received output signals SN[102]˜SN[n-1] to the drive circuits 110_103˜110_n. The drive circuits 110_103˜110_n output the output signals SN[103]˜SN[n] also having a refresh rate corresponding to 30 hertz (Hz) to the multiple electronic components P(1,103)˜P(m,n) of the 103rd row to the nth row.

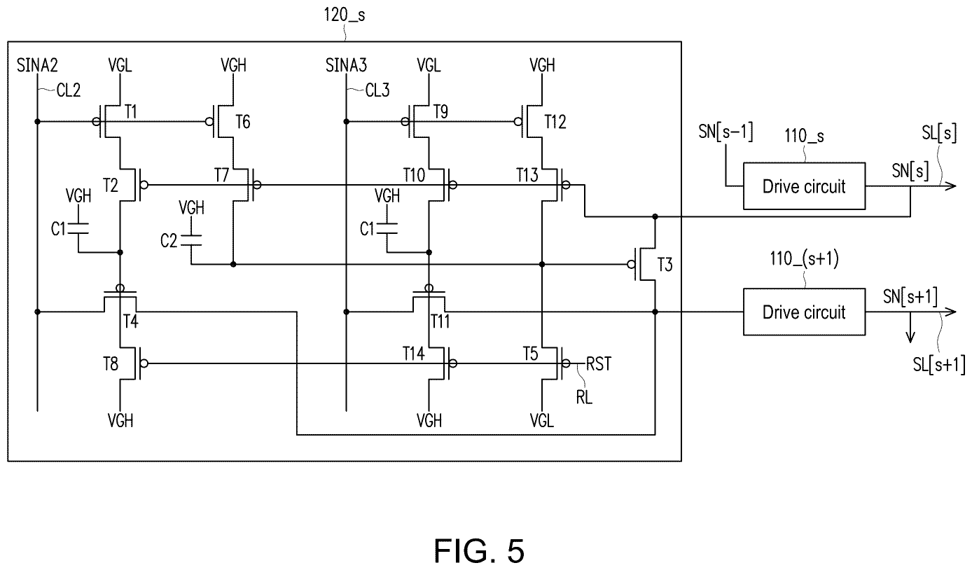

With reference to FIG. 5, the following description takes two adjacent drive circuits and one control circuit in FIG. 1 as an example. Each control circuit in FIG. 1 may implement the circuit architecture as shown in FIG. 5. Taking the electronic device 10 in FIG. 1 as an example, the control circuit 120_s is coupled to the drive circuit 110_s and the drive circuit 110_(s+1), where s is a positive integer between 1 and n. The input of the drive circuit 110_s receives a signal SN[s−1] from a previous stage. The output of the drive circuit 110_s may be coupled to multiple electronic components (not shown) through a signal line SL[s], and the output of the next stage drive circuit 110_(s+1) may be coupled to other multiple electronic components (not shown) through a signal line SL[s+1]. The control circuit 120_s includes transistors T1, T2, T6, T7, T9, T10, T12, T13 (judgment transistor), transistors T3, T4, T11 (input control transistor), transistors T5, T8, T14 (reset transistor), and capacitors C1˜C3.

The first terminal of the transistor T1 is coupled to the reference voltage VGL. The second terminal of the transistor T1 is coupled to the first terminal of the transistor T2. The control terminal of the transistor T1 is coupled to the input signal line CL2. The control terminal of the transistor T2 is coupled to the output terminal of the drive circuit 110_s. The second terminal of the transistor T2 is coupled to the control terminal of the transistor T4. The first terminal of the transistor T3 is coupled to the output terminal of the drive circuit 110_s. The second terminal of the transistor T3 is coupled to the input terminal of the drive circuit 110_(s+1). The first terminal of the transistor T4 is coupled to the input signal line CL2. The second terminal of the transistor T4 is coupled to the second terminal of the transistor T3 and the input terminal of the drive circuit 110_(s+1). The control terminal of the transistor T4 is coupled to the second terminal of the transistor T2. The first terminal of the transistor T5 is coupled to the control terminal of the transistor T3. The second terminal of the transistor T5 is coupled to the reference voltage VGL. The control terminal of the transistor T5 is coupled to the reset signal line RL. The first terminal of the capacitor C1 is coupled to the reference voltage VGH. The second terminal of the capacitor C1 is coupled to the second terminal of the transistor T2 and the control terminal of the transistor T4. The first terminal of the transistor T6 is coupled to the reference voltage VGH. The control terminal of the transistor T6 is coupled to the input signal line CL2. The first terminal of the transistor T7 is coupled to the second terminal of the transistor T6. The control terminal of the transistor T7 is coupled to the output terminal of the drive circuit 110_s. The second terminal of the transistor T7 is coupled to the control terminal of the transistor T3 and the first terminal of the transistor T5. The first terminal of the transistor T8 is coupled to the second terminal of the transistor T2 and the control terminal of the transistor T4. The second terminal of the transistor T8 is coupled to the reference voltage VGH. The control terminal of the transistor T8 is coupled to the reset signal line RL. The first terminal of the capacitor C2 is coupled to the reference voltage VGH. The second terminal of the capacitor C2 is coupled to the control terminal of the transistor T3. The connection relationship of the transistors T5, T9 ˜T19 may refer to the transistors T1˜T7 of FIG. 3. The first terminal of the transistor T14 is coupled to the second terminal of the transistor T10 and the control terminal of the transistor T11. The second terminal of the transistor T14 is coupled to the reference voltage VGH. The control terminal of the transistor T14 is coupled to the reset signal line RL. The transistors T1˜T14 are P-type transistors. The reference voltage VGL is lower than the second reference voltage VGH.

The signal SN[s] output from the output terminal of the drive circuit 110_s may be provided to the input terminal of the drive circuit 110_(s+1) via the transistor T3, so that the drive circuit 110_(s+1) generates the signal SN[s+1] according to the signal SN[s] of the previous stage.

The second input signal SINA2 may be provided to the input terminal of the drive circuit 110_(s+1) via the transistor T4, so that the drive circuit 110_(s+1) generates the signal SN[s+1] according to the second input signal SINA2. In other words, if the multiple electronic components driven by the drive circuit 110_s and the other multiple electronic components driven by the drive circuit 110_(s+1) are to operate in different operation modes respectively, then control may be achieved through the second input signal SINA2 transmitted by the input signal line CL2.

The third input signal SINA3 may be provided to the input terminal of the drive circuit 110_(s+1) via the transistor T11, so that the drive circuit 110_(s+1) generates the signal SN[s+1] according to the third input signal SINA3. In other words, if the multiple electronic components driven by the drive circuit 110_s and the other multiple electronic components driven by the drive circuit 110_(s+1) are to operate in different operation modes respectively, then control may be achieved through the third input signal SINA3 transmitted by the input signal line CL3. The control circuit 120_s receives the second input signal SINA2 and the third input signal SINA3, and the second input signal SINA2 and the third input signal SINA3 may be scan signals having different refresh rates or drive signals having different duty cycles.

In summary, the electronic device of the disclosure may control multiple electronic components disposed in the same substrate to respectively operate in operation modes of at least two different refresh rates or at least two different duty cycles.

What is claimed is:

1. An electronic device, comprising:
a substrate;
a first electronic component arranged in a first area of the substrate;
a second electronic component arranged in the first area of the substrate;
a first drive circuit arranged in a second area of the substrate, and coupled to the first electronic component;
a second drive circuit arranged in the second area of the substrate, and coupled to the second electronic component; and
a first control circuit arranged in the second area of the substrate, and coupled to the first drive circuit and the second drive circuit, wherein the first control circuit comprises a first judgment transistor, a second judgment transistor, a first input control transistor, a second input control transistor, a first reset transistor, and a first capacitor.

2. The electronic device according to claim 1, wherein the first drive circuit and the second drive circuit are respectively scan drive circuits, wherein the first drive circuit is configured to output a first scan signal to the first electronic component, and the second drive circuit is configured to output a second scan signal to the second electronic component.

3. The electronic device according to claim 1, wherein the first drive circuit and the second drive circuit are respectively emission drive circuits, wherein the first drive circuit is configured to output a first emission signal to the first electronic component, and the second drive circuit is configured to output a second emission signal to the second electronic component.

4. The electronic device according to claim 3, wherein the first control circuit is configured to operate the first electronic component and the second electronic component at same duty cycle or different duty cycles through the first drive circuit and the second drive circuit.

5. The electronic device according to claim 1, further comprising:
a third electronic component arranged in the first area of the substrate;
a fourth electronic component arranged in the first area of the substrate;
a third drive circuit arranged in the second area of the substrate, and coupled to the third electronic component;
a fourth drive circuit arranged in the second area of the substrate, and coupled to the fourth electronic component; and
a second control circuit arranged in the second area of the substrate, and coupled to the third drive circuit and the fourth drive circuit, wherein the first drive circuit, the second drive circuit, and the first control circuit are disposed on one side of the second area, and the third drive circuit, the fourth drive circuit, and the second control circuit are disposed on an opposite side of the second area.

6. The electronic device according to claim 1, wherein a first terminal of the first judgment transistor is coupled to a first reference voltage, and a second terminal of the first judgment transistor is coupled to a first terminal of the second judgment transistor, wherein a control terminal of the second judgment transistor is coupled to an output terminal of the first drive circuit, and a second terminal of the second judgment transistor is coupled to a control terminal of the second input control transistor, wherein a first terminal of the first input control transistor is coupled to the output terminal of the first drive circuit, and a second terminal of the first input control transistor is coupled to an input terminal of the second drive circuit, wherein a first terminal of the second input control transistor is coupled to a first input signal line, and a second terminal of the second input control transistor is coupled to the second terminal of the first input control transistor and the input terminal of the second drive circuit.

7. The electronic device according to claim 6, wherein a first terminal of the first reset transistor is coupled to the control terminal of the first input control transistor, and a second terminal of the first reset transistor is coupled to a second reference voltage.
